(19) United States
(12) Patent Application Publication
(10) Pub. No.: US 2021/0079918 A1
(43) Pub. Date: Mar. 18, 2021

(54) Exergy Surface Shaping and Thermodynamic Flow Control of Electro-Mechanical-Thermal Systems

(71) Applicants: National Technology & Engineering Solutions of Sandia, LLC, Albuquerque, NM (US); Michigan Technological University, Houghton, MI (US)

(72) Inventors: Wayne W. Weaver, Hancock, MI (US); Rush D. Robinett, III, Tijeras, NM (US); David G. Wilson, Tijeras, NM (US)

(21) Appl. No.: 17/019,217

(22) Filed: Sep. 12, 2020

Related U.S. Application Data
(60) Provisional application No. 62/899,967, filed on Sep. 13, 2019.

(51) Int. Cl. F04D 13/06; H02N 3/00; H02K 7/14

(52) U.S. Cl. CPC F04D 13/06; F41B 6/006; H02K 7/14; H02N 3/00

(57) ABSTRACT

This invention is directed to exergy surface shaping and thermodynamic flow control (ESSTFC) for electro-mechanical-thermal (EMT) systems (i.e., irreversible work processes with heat and mass flows). Extended irreversible thermodynamics are utilized to produce consistent thermal equations-of-motion that directly include the exergy destruction terms. A simplified EMT system that models the EMT dynamics of a ship equipped with a railgun is used to demonstrate the application of ESSTFC for designing high performance, stable nonlinear controllers for EMT systems.

### CROSS-REFERENCE TO RELATED APPLICATION

This application claims the benefit of U.S. Provisional Application No. 62/899,967, filed Sep. 13, 2019, which is incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to control of electro-mechanical-thermal (EMT) systems and, in particular, to exergy surface shaping and thermodynamic flow control of EMT systems.

### BACKGROUND OF THE INVENTION

Exergy from a physics standpoint is formally defined as the maximum amount of work that a subsystem can do on its surroundings as it approaches thermodynamic equilibrium reversibly, or the degree of distinguishability of a subsystem from its surroundings. Therefore, exergy can be used to measure and compare resource inputs and outputs which include wastes and losses. See R. Ayres, Ecol. Econ. 26(2), 189 (1998). Exergy is consumed, not conserved, just as the ‘energy’ of electro-mechanical (EM) systems is consumed, not conserved, when subjected to externally applied non-conservative forces (i.e., damping). It was shown by Robinett and Wilson that the Hamiltonian of EM systems (i.e., adiabatic irreversible work processes) is an exergy potential function which can be used as a Lyapunov function, a variational functional, as well as an optimization cost function for EM systems. See R. Robinett III and D. Wilson, Int. J. Exergy, 6(3), 357 (2009). Furthermore, Robinett and Wilson showed that the Hamiltonian and its time derivative can be used to design nonlinear controllers which meet necessary and sufficient conditions for stability via a procedure termed Hamiltonian surface shaping and power flow control (HSSPFC). See R. D. Robinett III and D. Wilson, Nonlinear Power Flow Control: Utilizing Exergy, Entropy, Static and Dynamic Stability and Lyapunov Analysis, Springer Complexity, London (2011).

The present invention extends HSSPFC for EM systems to electro-mechanical-thermal (EMT) systems, which is referred to herein as exergy surface shaping and thermodynamic flow control (ESSTFC). The extension of HSSPFC requires the development of exergy potential functions, irreversible entropy production terms of the entropy balance equation to obtain the exergy destruction terms for inclusion in the exergy balance equation, and variational principles for producing consistent equations of motion for coupled EMT systems.

### SUMMARY OF THE INVENTION

The invention is directed to exergy surface shaping and thermodynamic flow control (ESSTFC) of electro-mechanical-thermal (EMT) systems (i.e., irreversible work processes with heat and mass flows). As an example, a simplified EMT system that models the EMT dynamics of a ship equipped with a railgun was used to demonstrate the application of ESSTFC for designing high performance, stable nonlinear controllers for EMT systems. Simulations of the ship EMT system demonstrated that the extended irreversible thermodynamic (EIT)/2nd law models predict some behaviors and limitations not seen in the more standard 1st law models. In particular, the EMT system model shows that system stability is adversely affected at low and high temperatures due to thermal dynamics. The thermal dynamics of the non-zero relaxation term are on the same order as the EM dynamics which means that the thermal stability cannot be neglected. The simulation examples show that the system designer needs to have a full understanding of the parameters to be able to predict maximum stable operating conditions and proper sizing of components.

### BRIEF DESCRIPTION OF THE DRAWINGS

The detailed description will refer to the following drawings, wherein like elements are referred to by like numbers.

FIG. 1A illustrates the 1st law thermodynamics control volume. FIG. 1B illustrates 2nd law thermodynamics: entropy with flux exchange system.

FIG. 2 illustrates a conductive heat transfer example.

FIG. 3 is a schematic illustration of an EMT model.

FIG. 4 is a schematic illustration of a simplified railgun and cooling system.

FIG. 5 is a graph of pulse width modulated (PWM) load P_{load} used in the simulation examples. The PWM power signal has a magnitude \hat{P}, a duty cycle Dₚ, which has values (0-100%), and a period Tₚ.

FIGS. 6A-6D are time domain simulations of a 1st law model with a pulse load \hat{P}=50 kW, Dₚ=50%, Tₚ=1 s. FIG. 6A is a graph of P_{load}. FIG. 6B is a graph of the temperatures T_{R} and T_{c}. FIG. 6C is a graph of the temperature dependent resistance R_{Ls}. FIG. 6D is a graph of the bus voltage v_{Cb}.

FIG. 7 is a graph of bus voltage v_{Cb} with a pulse load \hat{P}=50 kW, Dₚ=50%, and Tₚ=1 s. The initial pulse is under-damped with growing oscillations at an initial low temperature T_{R}(t=0)=20° C.

FIG. 8A is a graph of time domain temperature T_{R} over a range of relaxation times τ for a pulse load \hat{P}=50 kW, Dₚ=50%, and Tₚ=1 s. FIG. 8B is a graph of the temperature T_{c}.

FIG. 9 is a graph of the maximum stable low temperature \hat{P} (Dₚ=50%, Tₚ=1 s) over a range of 2nd law parameter τ.

FIG. 10A is a graph of temperatures T_{R} and T_{c} for a simulation with a pulse load \hat{P}=50 kW, Dₚ=50%, Tₚ=1 s with 2^{nd} law parameter τ=100. FIG. 10B is a graph of bus voltage v_{Cb}.

FIG. 11 is a graph of the maximum stable high temperature \hat{P} (Dₚ=50%, Tₚ=1 s) over a range of 2nd law parameter τ. The values are discontinuous at τ=0.031.

FIG. 12 is a graph of the temperatures T_{R} and T_{c} for τ=0.031, \hat{P}=100 kW, Dₚ=50%, Tₚ=1 s.

### DETAILED DESCRIPTION OF THE INVENTION

The Hamiltonian for natural EM systems is an exergy potential function which leaves incomplete the development of exergy potential functions for the thermal part of the coupled models. See R. Robinett III and D. Wilson, Int. J. Exergy 6(3), 357 (2009). According to the present invention, this development is completed by integrating the exergy function over the control volume subject to the modelling assumptions. The integration of the control volume follows the procedure defined in Fung. See Y. Fung, Foundations of Solid Mechanics, Prentice-Hall, NJ (1965). In particular, the thermoelastic potential of Biot, which is equivalent to the exergy function for coupled thermo-elastic systems, is modified and utilized for EMT systems. See M. Biot, A Bulletin De La Classe Des Sciences 61(1), 6 (1975). This exergy potential function is a positive-definite, quadratic function of the relative temperature (i.e., the absolute temperature minus the reference/reservoir temperature).

Exergy destruction is a thermodynamic generalization of the concept of dissipation in mechanical systems and resistance in electrical systems which is a scaled version of irreversible entropy production. Exergy destruction is a measure that is often used to evaluate the efficiency of thermodynamic systems or processes. This metric can be used to design optimally efficient feedforward controllers while recognizing that exergy destruction is fundamental to the feedback closed-loop control stability of these systems and processes. Consequently, the optimization is a trade-off between minimum exergy destruction for maximum system efficiency versus meeting the minimum required exergy destruction for stability. Razmara et al. showed that exergy destruction can be used as an optimization cost function to increase the performance of mechanical-thermal systems without explicitly imposing the stability constraint. See M. Razmara et al., J. Appl. Energy 156(1), 555 (2015). Also, Razmara et al. showed that exergy destruction can be used as an optimization cost function to increase the performance of mechanical-thermal-combustion systems which utilize stable closed-loop controllers to track the optimal feedforward commands. See M. Razmara et al., J. Appl. Energy 183(1), 1389 (2016).

The exergy destruction terms of the exergy balance equation can be developed from the irreversible entropy production terms from the entropy balance equation for the optimization cost function. Kondepudi and Prigogine developed the general irreversible entropy production terms for partial-differential-equations (PDE) from chemical thermodynamic systems since irreversible entropy is used as the Lyapunov function for the concept of dissipative systems. See D. Kondepudi and I. Prigogine, Modern Thermodynamics: From Heat Engines to Dissipative Structures, John Wiley & Sons, NY (1999). Following Prigogine, Biot, and Fung, irreversible entropy production terms can be developed and multiplied by the reference/reservoir temperature to generate the exergy destruction terms for EMT systems. See I. Prigogine, Introduction to Thermodynamics of Irreversible Processes, 2nd ed., Wiley, NY (1961); M. A. Biot, Appl. Phys. 27(3), 240 (1956); M. Biot, Bulletin De La Classe Des Sciences 61(1), 6 (1975); and Y. Fung, Foundations of Solid Mechanics, Prentice-Hall, NJ (1965). Also, Gyftopoulus and Beretta provide a development of these irreversible entropy production terms based on bulk-flow thermodynamic models. See E. Gyftopoulus and G. Beretta, Thermodynamics: Foundations and Applications, Dover Publications, NY (2005). Unfortunately, these exergy destruction terms are not included in the equations-of-motion for the thermal system. One way to directly include the exergy destruction terms within the thermal equations-of-motion is to utilize extended irreversible thermodynamics (EIT) and Cattaneo's Law to produce a consistent set of equations-of-motion for the EMT systems. See G. Lebon et al., Understanding Non-Equilibrium Thermodynamics, Vol. 295, Springer, Berlin (2008). Cattaneo's Law produces a thermal wave model by modifying Fourier's law of heat conduction by adding a heat flux relaxation term which creates a 2nd order differential equation in temperature. This 2nd order equation has the same form as a 2nd order mass-spring-damper model where the temperature replaces the mass position. As will be described below, a simplified EMT system was used to model the EMT dynamics of a ship equipped with a railgun. The model demonstrates the quantitative and qualitative differences between thermal models based on a zero versus a non-zero relaxation term. Since the railgun is being subjected to a thermal pulse during the firing of a projectile, the thermal response of the railgun thermal mass and the cooling system may be better predicted by a thermal wave model.

There are several variational principles that are available for application to EMT systems. Recently, Gay-Balmaz and Yoshimura developed a Lagrangian variational formulation for nonequilibrium thermodynamics (both continuum and discrete systems) that is based on the works of Onsager, Kondepudi and Prigogine, Biot, Gyarmati, and many others. See F. Gay-Balmaz and H. Yoshimura, J. Geom. Phys. 111(1), 169 (2016a); F. Gay-Balmaz and H. Yoshimura, J. Geom. Phys. 111(1), 194 (2016b); L. Onsager, Phys. Rev. 37(4), 405 (1931); D. Kondepudi and I. Prigogine, Modern Thermodynamics: From Heat Engines to Dissipative Structures, John Wiley & Sons, NY (1999); M. Biot, A Bulletin De La Classe Des Sciences 61(1), 6 (1975); and I. Gyarmati et al., Non-Equilibrium Thermodynamics, Springer, Berlin (1970). This Lagrangian variational formulation is quite general and these references provide a good background and history of variational principles applied to nonequilibrium thermodynamic systems. This invention focusses on the modification and application of the variational principles developed by Biot and Fung for coupled thermoelasticity. See M. Biot, A Bulletin De La Classe Des Sciences 61(1), 6 (1975); and Y. Fung, Foundations of Solid Mechanics, Prentice-Hall, NJ (1965). Effectively, the extended Hamilton's principle of Meirovitch for EM systems is appended with the modified thermo-exergy potential function of Biot and the modified exergy destruction-dissipation function of Fung. See L. Meirovitch, Methods of Analytical Dynamics, McGraw-Hill, New York (1970).

In summary, given that any real process has exergy destruction, the goal of the controller design of the present invention is to:

1. Design optimal feedforward controllers that minimize the exergy destruction intrinsic within the EMT system. See G. G. Parker et al., ‘Exergy analysis of ship power systems’, in International Ship Control Systems Symposium, INEC, pp. 1-6 (2018); and E. H. Trinklein et al., ‘Reduced order multi-domain modeling of shipboard systems for exergy-based control investigations’, in ASNE Technology, Systems and Ships Symposia, ASNE, pp. 1-6 (2018).

2. Operate the EMT system with minimum additional exergy destruction due to the feedback controller while simultaneously meeting the system requirements and constraints including nonlinear stability of the overall coupled EMT system.

These two goals can be met by applying the ESSTFC developed herein to EMT systems. The novelty of ESSTFC for EMT systems is:
The extension of HSSPFC for EM systems to EMT systems.
The utilization of the exergy potential function as a Lyapunov function, a variational functional, as well as an optimization cost function for EMT systems.
The use of the exergy potential function and it's time derivative for the design of nonlinear controllers which meet necessary and sufficient conditions for stability for a large class of nonlinear EMT systems.
The development of exergy potential functions for thermal systems based on the 1st law as well as EIT and Cattaneo's Law which determine the necessary conditions for stability of EMT systems.
The development of exergy destruction terms for thermal systems based on the 1st law as well as EIT and Cattaneo's Law for the use in nonlinear control design.
The application of the extended Hamilton's principle to the exergy potential function as well as the generalized virtual work terms from the exergy destruction terms.
The sorting of the thermodynamic flow terms of the exergy rate equations into three classes of ‘generalized power flows’: into the system (power generators), out of the system (power dissipators), and stored within the system (power storage). The balance of these thermodynamic flows will determine the sufficient conditions for stability of EMT systems.
Finally, a consistent set of coupled equations of motion for EMT systems is derived where the thermal model includes the exergy destruction as ‘generalized dissipation terms’.

Also, the ESSTFC is applied to a simplified EMT system that models the EMT dynamics of a ship equipped with a railgun to demonstrate the design process for high performance, optimal, stable nonlinear controllers for EMT systems. The ESSTFC is applied to two different thermal models to investigate the quantitative and qualitative differences between thermal models based on a zero versus a non-zero relaxation term.

The results of this analysis are:
The coupled EMT system indicates a controller where the temperature cannot be too high (i.e., the resistance is too high and chokes the current), but it cannot be too low (i.e., a low resistance will not suppress the oscillations generated by the pulse train) which means the cooling system could be undersized or oversized.
The thermal dynamics of the non-zero relaxation term are on the same order as the EM dynamics and show similar meta-stability behavior which means the thermal stability cannot be neglected.

### Exergy Equations, Potential Functions, and Destruction Terms

The exergy equation for discrete systems is defined in terms of the 1st and 2nd laws of thermodynamics. Mathematically, a result of the 1st law can be written in terms of its time derivatives or energy rate for a system as

$$\dot{ɛ} = {Σ}_{i} {\dot{Q}}_{i} + {Σ}_{j} {\dot{W}}_{j} + {Σ}_{k} {\dot{m}}_{k} ( {h}_{k} + {ke}_{k} + {pe}_{k} + … ) . \qquad ( 1 )$$

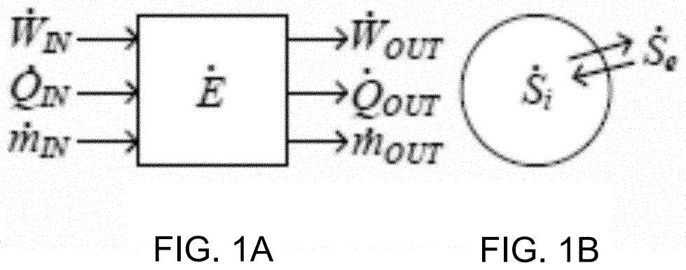

See D. Scott, Int. J. Hydrog. Energy 28(4), 369 (2003). The term on the left represents the rate at which energy is changing within the system. The heat entering and/or leaving the system is given by \dot{Q}ᵢ and the work being done on and/or by the system is given by \dot{W}ⱼ. Next, material can enter or leave the system by \dot{m}ₖ that includes enthalpy, hₖ, kinetic and potential energies, keₖ+peₖ, etc. In addition, each term is summed over an arbitrary number of entry and exit locations i, j, k, as shown in FIG. 1A.

A result of the 2nd law, is the entropy rate equation for a system given as

$$\dot{S} = {Σ}_{i} \frac{{\dot{Q}}_{i}}{{T}_{i}} + {Σ}_{k} {\dot{m}}_{k} {s}_{k} + {\dot{S}}_{ir} = {\dot{S}}_{e} + {\dot{S}}_{ir} . \qquad ( 2 )$$

See D. Scott, Int. J. Hydrog. Energy 28(4), 473 (2003). Here the left-hand term is the rate entropy changes within the system and the right-hand terms represent, in order, the rate heat conducts entropy to and from the system and the rate material carries it in or out. These two terms can be combined into one term \dot{S}ₑ, the entropy exchanged (either positive or negative) with the environment and \dot{S}ₗᵣ is the irreversible entropy production rate within the system. FIG. 1B shows the entropy exchanges and production within the system. The irreversible entropy production rate can be written as

$${\hat{S}}_{ir} = {Σ}_{k} {F}_{k} {\dot{X}}_{k} \geq 0 \qquad ( 3 )$$

where the entropy change is the sum of all the changes due to the irreversible flows \dot{X}ₖ with respect to each corresponding thermodynamic force Fₖ. See D. Kondepudi and I. Prigogine, Modern Thermodynamics: From Heat Engines to Dissipative Structures, John Wiley & Sons, NY (1999). Next, for systems with a constant environmental temperature, a thermodynamic quantity called the availability function, which has the same form as the Helmholtz free energy function, is defined as

$$Ξ = ɛ - {T}_{0} S \qquad ( 4 )$$

where T₀ is the reference environmental temperature. The availability function is the system exergy, described as the maximum theoretically available energy that can do work. Exergy is also known as negative-entropy. See D. Scott, Int. J. Hydrog. Energy 28(4), 369 (2003); and D. Scott, Int. J. Hydrog. Energy 28(4), 473 (2003). By taking the time derivative of the exergy, equation (4), and substituting in the expressions for equations (1) and (2) results in the exergy rate equation

$$\dot{Ξ} = {Σ}_{i} ( 1 - \frac{{T}_{o}}{{T}_{i}} ) {\dot{Q}}_{i} + {Σ}_{j} ( {\dot{W}}_{j} - {p}_{0} \frac{d \overline{V}}{dt} ) + {Σ}_{k} {\dot{m}}_{k} {ζ}_{k}^{flow} - {T}_{o} {\dot{S}}_{ir} \qquad ( 5 )$$

where \dot{Ξ} is the rate at which exergy stored within the system is changing. The terms on the right of equation (5) define the rate exergy is carried in or out. Specifically, the terms of equation (5) are heat, work (less any work the system does on the environment) and the material (or quantity known as flow exergy). The final term, T₀\dot{S}ₗᵣ, is the rate exergy is destroyed (or dissipated) within the system. The exergy rate equation is modified for the EMT systems by removing the

$${p}_{0} \frac{d \overline{V}}{dt}$$

term such that

$$\dot{Ξ} = {\sum }_{i} ( 1 - \frac{{T}_{0}}{{T}_{i}} ) {\dot{Q}}_{i} + {\sum }_{j} {\dot{W}}_{j} + {\sum }_{k} {\dot{m}}_{k} {ζ}_{k}^{flow} - {T}_{0} {\dot{S}}_{ir} . \qquad ( 6 )$$

A summary of pertinent terms and descriptions are given in Table 1.

TABLE 1
Summary of exergy equation terms

| Variable | Description |
|---|---|
| [symbol] | The heat entering and/or leaving the system |
| W [symbol] | The work being done on and/or by the system |
| [symbol] | The rate at which exergy stored within the system is changing |
| [symbol] | The entropy exchanged (either positive or negative) |
| [symbol] | The irreversible entropy production rate |
| T [symbol] | Reference environment temperature |
| T [symbol] | Internal system temperature |
| [symbol] | Environmental pressure |
| [symbol] | System volume |
| [symbol] | Mass flow rate |

[symbol]

indicates data missing or illegible when filed

### Exergy Potential Functions

The exergy potential functions for the EMT systems of interest are the Hamiltonian for the EM systems and the modified thermoelastic potential of Biot. See R. Robinett III and D. Wilson, Int. J. Exergy, 6(3), 357 (2009); M. Biot, A Bulletin De La Classe Des Sciences 61(1), 6 (1975); and Y. Fung, Foundations of Solid Mechanics, Prentice-Hall, NJ (1965). The energy storage terms of the Hamiltonian for the mechanical systems are the kinetic energy and potential energy such as

$${H}_{m} = \frac{1}{2} {Mv}^{2} + \frac{1}{2} {Kx}^{2} = {T}_{m} + {V}_{m} \qquad ( 7 )$$

where M is the mass, v is the velocity, K is the stiffness constant, x is the displacement, Tₘ is the mechanical kinetic energy, and Vₘ is the mechanical potential energy. The energy storage terms of the Hamiltonian for the electrical systems are typically associated with the capacitance and inductance of the electrical network such as

$${H}_{e} = \frac{1}{2} {CV}^{2} + \frac{1}{2} {LI}^{2} \qquad ( 8 )$$

where C is the capacitance, V is the voltage, L is the inductance, and I is the current. These terms are equivalent to mechanical kinetic and potential energy depending upon whether the network is voltage-controlled or current-controlled.

The exergy potential function for the thermal system is derived from the availability function, equation (4). Following the derivation by Fung, the integral of equation (4) from the PDE formulation is

$$\begin{matrix} {V}_{t} = {\text{?}}^{ } ρ ( ɛ - {T}_{0} S ) d θ = \text{?} d \text{?} ( {\int }_{0}^{θ} ρ {C}_{p} d θ - {T}_{0} {\int }_{0}^{θ} \frac{ρ {C}_{p} d θ}{{T}_{0} + θ} ) ( 9 ) \\ = \text{?} d θ {\int }_{0}^{θ} \frac{ρ {C}_{p} θ d θ}{{T}_{0} + θ} .\end{matrix}$$

$$\text{?} \text{indicates text missing or illegible when filed}$$

For T₀»θ, then

$${V}_{t} = \text{?} \frac{ρ {C}_{p} {θ}^{2}}{2 {T}_{0}} d \text{?} . \\ \text{?} \text{indicates text missing or illegible when filed} \qquad ( 10 )$$

For ρ=constant, then

$${V}_{t} = \frac{ρ \hat{V} {C}_{p} {θ}^{2}}{2 {T}_{0}} \qquad ( 11 )$$

where ρ is the density, Cₚ is the specific heat, θ is the relative temperature, and Vₜ is the exergy potential function. As an example of the invention, this exergy potential function will be used for the thermal mass and the bulk fluid flow in the ship and railgun example described below.

### Exergy Destruction Terms

The irreversible entropy production terms are the exergy destruction terms of the exergy balance equation and the generalization of the mechanical dissipation and electrical resistance within EM systems. Irreversibilities cause work loss in EMT systems. Examples of these irreversibilities include, but are not limited to friction, heat transfer, mixing of air flows in a room, compression, and expansion of gases in a system. See D. Kondepudi and I. Prigogine, Modern Thermodynamics: From Heat Engines to Dissipative Structures, John Wiley & Sons, NY (1999); and E. Gyftopoulus and G. Beretta, Thermodynamics: Foundations and Applications, Dover Publications, NY (2005).

The exergy destruction terms for the EMT systems of interest are based upon the mechanical friction damping and electrical resistance for the EM systems and the irreversible entropy production of the heat transfer. See R. Robinett III and D. Wilson, Int. J. Exergy 6(3), 357 (2009); Y. Fung, Foundations of Solid Mechanics, Prentice-Hall, NJ (1965); and D. Kondepudi and I. Prigogine, Modern Thermodynamics: From Heat Engines to Dissipative Structures, John Wiley & Sons, NY (1999). The irreversible entropy production terms for mechanical systems can be written in terms of equation (3)

$${( {\dot{S}}_{ir} )}_{m} = \text{?} {F}_{l} {\dot{X}}_{l} = \frac{1}{{T}_{0}} \text{?} {f}_{l} {v}_{l} \geq 0 \\ \text{?} \text{indicates text missing or illegible when filed} \qquad ( 12 )$$

where fₗ is the l^{th} generalized externally applied non-conservative force and vₗ is the l^{th} generalized velocity. See R. Robinett III and D. Wilson, Int. J. Exergy 6(3), 357 (2009). Equation (12) is a scaled mechanical power flow. The generalized externally applied non-conservative forces of interest include viscous damping

$$\text{?} = {c}_{m} {v}_{l} \\ \text{?} \text{indicates text missing or illegible when filed} \qquad ( 13 )$$

where cₘ is the viscous damping coefficient.

The irreversible entropy production terms for electrical systems can be written in terms of equation (3) as

$$( \text{?} ) \text{?} = {\sum }_{k} {F}_{k} {\dot{X}}_{k} = \frac{1}{{T}_{0}} {\sum }_{k} {f}_{k} {I}_{k} \geq 0 \\ \text{?} \text{indicates text missing or illegible when filed} \qquad ( 14 )$$

where fₖ is the k^{th} generalized applied voltage and lₖ is the k^{th} generalized current. See R. Robinett III and D. Wilson, Int. J. Exergy 6(3), 357 (2009). Equation (14) is a scaled electrical power flow. The generalized applied voltages of interest include electrical resistance

$${f}_{k} = {R}_{c} {I}_{k} \qquad ( 15 )$$

where Rₑ is the electrical resistance coefficient.

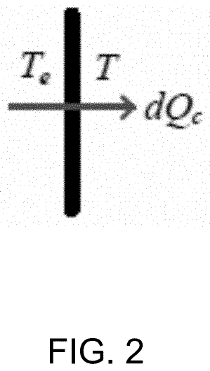

The irreversible entropy production terms for thermal systems can be written in terms of equation (3). For conductive heat transfer shown in FIG. 2,

$$\begin{matrix}{( {dS}_{ir} )}_{cond} = - \frac{{dQ}_{c}}{{T}_{c}} + \frac{{dQ}_{c}}{T} = [ \frac{1}{T} - \frac{1}{{T}_{c}} ] {dQ}_{c} = {F}_{k} {dX}_{k} & ( 16 ) \\ {( \frac{{dS}_{ir}}{dt} )}_{cond} = [ \frac{{T}_{c} - T}{{T}_{c} T} ] \frac{{dQ}_{c}}{dt} = \frac{{k}_{c} {{A}_{c} ( {T}_{c} - T )}^{2}}{{T}_{c} T} = {F}_{k} {\dot{X}}_{k} \\ where & ( 17 ) \\ {\dot{Q}}_{c} = - {k}_{c} {A}_{c} ( T - {T}_{c} ) & ( 18 )\end{matrix}$$

and k_{c} is the conductive heat transfer rate coefficient, A_{c} is the cross-sectional area, and T is the temperature. This is an example of utilizing the 2nd law to determine the irreversible entropy production and exergy destruction for an optimization cost function for feedforward control design. See G. G. Parker et al., ‘Exergy analysis of ship power systems’, in International Ship Control Systems Symposium, INEC, pp. 1-6 (2018); and E. H. Trinklein et al., ‘Reduced order multi-domain modeling of shipboard systems for exergy-based control investigations’, in ASNE Technology, Systems and Ships Symposia, ASNE, pp. 1-6 (2018). To directly include the exergy destruction terms within the thermal equations-of-motion, EIT and Cattaneo's Law are utilized to produce a consistent set of equations-of-motion for the EMT systems, as described below.

### Variational Principles, Exergy Surface Shaping, and Thermodynamic Flow Control

There are several variational principles that are available for application to EMT systems. The extended Hamilton's principle for EM systems is appended with the modified thermo-exergy potential function and the modified exergy destruction-dissipation function. See L. Meirovitch, Methods of Analytical Dynamics, McGraw-Hill, New York (1970); M. Biot, A Bulletin De La Classe Des Sciences 61(1), 6 (1975); and Y. Fung, Foundations of Solid Mechanics, Prentice-Hall, NJ (1965). Robinett and Wilson present the relationships between Hamiltonian natural systems and adiabatic irreversible work processes

$$\dot{Ξ} = {\sum }_{j} {\dot{W}}_{j} - {T}_{0} \text{?} \\ \text{?} \text{indicates text missing or illegible when filed} \qquad ( 19 )$$

which leads to a direct connection to the extended Hamilton's principle

$${\int }_{{t}_{1}}^{{t}_{2}} ( δ {T}_{m} + \overline{δ W} ) dt = 0 \qquad ( 20 )$$

where δ̅W̅ is the virtual work of the applied forces including forces derivable from potential function (Vₘ). Equation (20) produces the equation-of-motion for EM systems in the form of either Lagrange's equations or Hamilton canonical equations. See R. Robinett III and D. Wilson, Int. J. Exergy 6(3), 357 (2009); R. D. Robinett III and D. Wilson, Nonlinear Power Flow Control: Utilizing Exergy, Entropy, Static and Dynamic Stability and Lyapunov Analysis, Springer Complexity, London (2011); and L. Meirovitch, Methods of Analytical Dynamics, McGraw-Hill, New York (1970).

The next step is to address the addition of the heat flow terms, the work rate terms (i.e., the system is performing work on the surroundings), and the mass flow terms of equation (6). Biot and Fung accomplish this by utilizing the thermoelastic potential of Biot in the modified variational formulation

$${\int }_{{t}_{1}}^{{t}_{2}} ( δ {V}_{t} + δ {D}_{t} δ {T}_{m} + \overline{δ W} ) dt = 0 \qquad ( 21 )$$

where δVₜ is the variation of the exergy potential function and δDₜ is the variation of the generalized (Rayleigh) dissipation function. See M. Biot, A Bulletin De La Classe Des Sciences 61(1), 6 (1975); and Y. Fung, Foundations of Solid Mechanics, Prentice-Hall, NJ (1965). Equation (21) produces the equations-of-motion for EMT systems in the form of exergy equations.

### Exergy Surface Shaping and Thermodynamic Flow Control

For an EMT system to be asymptotically stable, it must be both statically stable and dynamically stable about an equilibrium point. The static stability requirement can be stated as: the exergy potential function must be positive definite about an equilibrium point. See R. D. Robinett III and D. Wilson, Nonlinear Power Flow Control: Utilizing Exergy, Entropy, Static and Dynamic Stability and Lyapunov Analysis, Springer Complexity, London (2011). This exergy potential function provides the necessary conditions for stability of EMT systems. For EMT systems of interest, the exergy potential function is a positive-definite, quadratic function of the state variables including the relative temperature.

The dynamic stability requirement can be stated as: the sum of the thermodynamic flows must be negative definite over a representative cycle in time. See R. D. Robinett III and D. Wilson, Nonlinear Power Flow Control: Utilizing Exergy, Entropy, Static and Dynamic Stability and Lyapunov Analysis, Springer Complexity, London (2011). The thermodynamic flow terms of the exergy rate equations can be sorted to ‘generalized power flows’ into the system (power generators), out of the system (power dissipators), and stored within the system (power storage). The balance of these thermodynamic flows will determine the sufficient conditions for stability of EMT systems. For the railgun example, the dynamic stability requirement can be modified to determine the stability of a nonlinear limit cycle. See R. Robinett III and D. Wilson, Int. J. Exergy 6(3), 357 (2009); and W. W. Weaver et al., IEEE Trans. Energy Conyers. 32(2), 820 (2017).

### Ship with Railgun Example

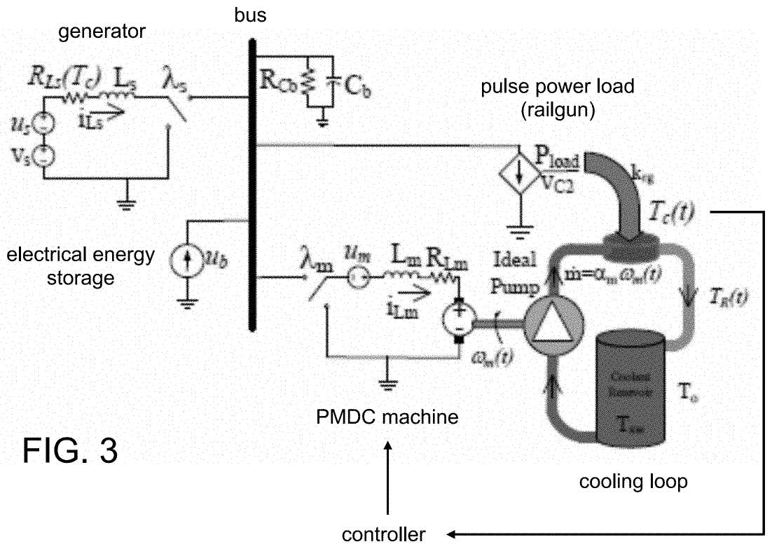

The simplified EMT system that models the EMT dynamics of a ship equipped with a railgun can be used to demonstrate the application of ESSTFC for designing high performance, stable nonlinear controllers for EMT systems. This model includes an extended reduced order electrical circuit with an ideal power generator, permanent magnet DC (PMDC) machine, pulse power load, electrical energy storage, and a PMDC pump connected to a thermal cooling loop with a thermal storage tank. The overall hybrid circuit EMT model is shown in FIG. 3.

### Hybrid EMT with 1st Law Thermal Model

The electrical circuit models follow the developments in Weaver et al. See W. Weaver et al., J. Control Eng. Pract. 44(1), 10 (2015); and W. Weaver et al., Int. J. Elec. Power 68(1), 203 (2015). The mechanical models are obtained from Ogata while the thermal models are simplified versions in Razmara et al. The model states are defined in Table 2. See K. Ogata, Modern Control Engineering, Prentice-Hall Inc., Englewood Cliffs, N.J. (1970); and M. Razmara et al., J. Appl. Energy 156(1), 555 (2015). The model variables and parameter values for the simulation are given in Table 3.

TABLE 2
States variables

| Variable | Description |
|---|---|
| [symbol] | Generator dc/dc converter current |
| [symbol] | Bus voltage |
| [symbol] | Cooling water pump dc/dc converter current |
| [symbol] | Cooling water pump speed |
| T [symbol] | Pulse load mass temperature |
| T [symbol] | Return cooling water temperature |
| R [symbol] | Generator dc/dc converter resistance |

[symbol]

indicates data missing or illegible when filed

TABLE 3
Model parameters

| Parameter | Description | Value | |
|---|---|---|---|
| [symbol] | Generator dc/dc converter duty cycle | 50% | |
| [symbol] | Cooling pump dc/dc converter duty cycle | 50% | |
| [symbol] | Generator voltage source | 135 | V_{DC} |
| [symbol] | Generator energy storage device | 0 | A |
| [symbol] | Cooling pump energy storage device | 0 | A |
| L [symbol] | Generator dc/dc converter inductance | 0.1 | mH |
| L [symbol] | Cooling dc/dc converter inductance | 5 | mH |
| R [symbol] | Cooling pump dc/dc converter resistance | 25 | mΩ |
| J [symbol] | Cooling pump inertia | 0.01 | kg · m² |
| D [symbol] | Cooling pump viscous damping coefficient | 0.4 | Nm/(rad/s)) |
| k [symbol] | PMDC torque coefficient | 3 | Nm/A |
| [symbol] | Cooling pump mass volume coefficient | 1.4 × 10⁻⁴ | Nm/(rad/s))² |
| [symbol] | Cooling pump mass flow rate coefficient | 0.05 | kg · m² |
| [symbol] | Cooling mass flow rate | — | |
| R [symbol] | Nominal series resistance | 1 | mΩ |
| [symbol] | Cooling pump mass flow rate coefficient | 0.25 | Ω/degree |
| C [symbol] | Pulse load mass specific heat ( [symbol] ) | 1,000 | J/kg K |
| R [symbol] | Pulse load mass heat transfer coefficient | 25 W/20° C. | |
| [symbol] | Pulse load power thermal gain (1 − [symbol] ) | 0.5 | |
| C [symbol] | Return coolant specific heat | 100 | J/kg |
| R [symbol] | Return coolant heat transfer coefficient | 10 W/20° C. | |
| T [symbol] | Supply coolant temperature | 20° | C. |
| R [symbol] | Bus resistance load | 50 | Ω |

[symbol]

indicates data missing or illegible when filed

The lumped electro-thermal coupling is modelled as a temperature dependent resistance

$${R}_{Ls} ( {T}_{c} ) = {R}_{Larcf} ( 1 + {α}_{R} ( {T}_{c} ( t ) - {T}_{o} ) ) 0 < {α}_{R} ≪ 1 \qquad ( 22 )$$

where α_{R} is the temperature coefficient of resistance and R_{Lsref} is the nominal parasitic resistance of the converter. See A. R. Hefner and D. L. Blackburn, ‘Simulating the dynamic electro-thermal behavior of power electronic circuits and systems’, in IEEE Workshop on Computers in Power Electronics, IEEE, pp. 143-151 (1992); and A. Ammous et al., IEEE Trans. Power Electr. 14(2), 300 (1999). The electrical model of FIG. 3 is given as

$$\begin{matrix} {L}_{s} \frac{{di}_{Ls}}{dt} = - {λ}_{s} {v}_{Cb} - {R}_{Ls} ( {T}_{c} ) {i}_{Ls} + {u}_{s} + \text{?} & ( 23 ) \\ {C}_{b} \frac{{dv}_{Cb}}{dt} = {u}_{b} - \frac{{v}_{Cb}}{{R}_{Cb}} - \frac{{P}_{load}}{{v}_{Cb}} - {λ}_{m} {i}_{Lm} + {λ}_{s} {i}_{Ls} & ( 24 ) \\ {L}_{m} \frac{{di}_{Lm}}{dt} = {λ}_{m} {v}_{Cb} - {R}_{Lm} {i}_{Lm} - {k}_{m} {ω}_{m} + {u}_{m} . \\ \text{?} \text{indicates text missing or illegible when filed} & ( 25 )\end{matrix}$$

The mechanical model of the PMDC is

$${J}_{m} \frac{d {ω}_{m}}{dt} = - {D}_{m} {ω}_{m} + {k}_{m} {i}_{Lm} - {γ}_{m} {ω}_{m}^{2} . \qquad ( 26 )$$

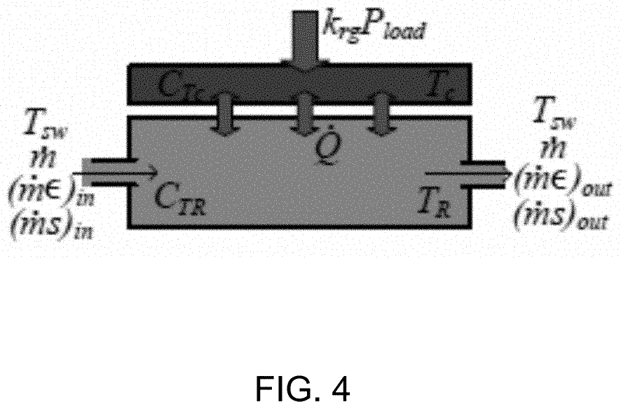

The simplified thermal models depicted in FIG. 4 are based on the energy balance equation (i.e., 1st law models)

$$\begin{matrix} {C}_{Tc} \frac{{dT}_{c}}{dt} = {R}_{12} ( {T}_{R} - {T}_{c} ) + {k}_{rg} {P}_{load} & ( 27 ) \\ {C}_{TR} \frac{{dT}_{R}}{dt} = {R}_{12} ( {T}_{c} - {T}_{R} ) + {α}_{m} {ω}_{m} {R}_{u} ( \text{?} - {T}_{R} ) \text{?} \\ where & ( 28 ) \\ \dot{m} = {α}_{m} {ω}_{m} \\ \text{?} \text{indicates text missing or illegible when filed} & ( 29 )\end{matrix}$$

See M. Razmara et al., J. Appl. Energy 156(1), 555 (2015).
Equations (23)-(28) can be written in matrix form as

$$\begin{matrix}\begin{matrix}M \dot{x} = Rx + f ( x , u , v , t ) + {B}^{T} u + {D}^{T} v \\ = ( \tilde{R} + \overline{R} ) x + f ( x , u , v , t ) + {B}^{T} u + {D}^{T} v\end{matrix} & ( 30 ) \\ {x}^{T} = ( {i}_{Ls} , {v}_{Cb} , {i}_{Lm} , {ω}_{m} , {T}_{c} , {T}_{R} ) & ( 31 ) \\ {u}^{T} = ( {u}_{a} , {u}_{b} , {u}_{m} , {T}_{sw} ) & ( 32 ) \\ {v}^{T} = ( {v}_{s} , {P}_{Load} ) & ( 33 ) \\ M = [ \begin{matrix}{L}_{s} & 0 & 0 & 0 & 0 & 0 \\ 0 & {C}_{b} & 0 & 0 & 0 & 0 \\ 0 & 0 & {L}_{m} & 0 & 0 & 0 \\ 0 & 0 & 0 & {J}_{m} & 0 & 0 \\ 0 & 0 & 0 & 0 & {C}_{Tc} & 0 \\ 0 & 0 & 0 & 0 & 0 & {C}_{TR}\end{matrix} ] , \\ {B}^{T} = [ \begin{matrix}1 & 0 & 0 & 0 \\ 0 & 1 & 0 & 0 \\ 0 & 0 & 1 & 0 \\ 0 & 0 & 0 & 0 \\ 0 & 0 & 0 & 0 \\ 0 & 0 & 0 & 0\end{matrix} ] , \\ {D}^{T} = [ \begin{matrix}1 & 0 \\ 0 & 0 \\ 0 & 0 \\ 0 & {k}_{rg} \\ 0 & 0\end{matrix} ] & ( 34 ) \\ R = [ \begin{matrix}- {R}_{Larcf} & - {λ}_{s} & 0 & 0 & 0 & 0 \\ {λ}_{s} & - {R}_{Cb}^{- 1} & - {λ}_{m} & 0 & 0 & 0 \\ 0 & {λ}_{m} & - {R}_{Lm} & - {k}_{m} & 0 & 0 \\ 0 & 0 & {k}_{m} & - {D}_{m} & 0 & 0 \\ 0 & 0 & 0 & 0 & - {R}_{12} & {R}_{12} \\ 0 & 0 & 0 & 0 & {R}_{12} & - {R}_{12}\end{matrix} ] \\ R = [ \begin{matrix}- {R}_{Larcf} & 0 & 0 & 0 & 0 & 0 \\ 0 & - {R}_{Cb}^{- 1} & 0 & 0 & 0 & 0 \\ 0 & 0 & - {R}_{Lm} & 0 & 0 & 0 \\ 0 & 0 & 0 & - {D}_{m} & 0 & 0 \\ 0 & 0 & 0 & 0 & - {R}_{12} & {R}_{12} \\ 0 & 0 & 0 & 0 & {R}_{12} & - {R}_{12}\end{matrix} ] , & ( 35 ) \\ \tilde{R} = [ \begin{matrix}0 & - {λ}_{m} & 0 & 0 & 0 & 0 \\ {λ}_{s} & 0 & - {λ}_{m} & 0 & 0 & 0 \\ 0 & {λ}_{m} & 0 & - {k}_{m} & 0 & 0 \\ 0 & 0 & {k}_{m} & 0 & 0 & 0 \\ 0 & 0 & 0 & 0 & 0 & 0 \\ 0 & 0 & 0 & 0 & 0 & 0\end{matrix} ] . & ( 36 )\end{matrix}$$

The vector of nonlinear model components is

$$f ( x , u , v , t ) = [ \begin{matrix}- {R}_{Lsrcf} {α}_{R} ( {T}_{c} ( t ) - \text{?} ) {i}_{Ls} \\ - \frac{{P}_{lead}}{{v}_{Cb}} \\ 0 \\ - {γ}_{m} {ω}_{m}^{2} \\ 0 \\ {α}_{m} {ω}_{m} {R}_{u} ( {T}_{sw} - {T}_{R} )\end{matrix} ] \\ \text{?} \text{indicates text missing or illegible when filed} \qquad ( 37 )$$

### ESSTFC Design for 1st Law Model

The exergy potential function for this 1st law EMT system is

$$\begin{matrix}{V}_{Ξ} = {H}_{m} + \text{?} + {H}_{t} \\ = \frac{{J}_{m} {ω}_{m}^{2}}{2} + \frac{{L}_{s} {i}_{Ls}^{2}}{2} + \frac{{C}_{b} {v}_{Cb}^{2}}{2} + \frac{{L}_{m} {i}_{Lm}^{2}}{2} + \frac{{C}_{Tc} {θ}_{c}^{2}}{2 {T}_{0}} + \frac{{C}_{TR} {θ}_{R}^{2}}{2 {T}_{0}} \\ = \frac{1}{2} {x}^{T} M x\end{matrix} \\ \text{?} \text{indicates text missing or illegible when filed} \qquad ( 38 )$$

where the relative temperatures are defined as θ_{c}=(T_{c}−T₀) and θ_{R}=(T_{R}−T₀). Equation (30) is modified with the relative temperatures.

$$\begin{matrix}\begin{matrix}M \dot{x} = Rx + f ( x , u , v , t ) + {B}^{T} u + {D}^{T} v \\ = ( \tilde{R} + \overline{R} ) x + f ( x , u , v , t ) + {B}^{T} u + {D}^{T} v\end{matrix} & ( 39 ) \\ {x}^{T} = ( {i}_{Ls} , {v}_{Cb} , {i}_{Lm} , {ω}_{m} , {θ}_{c} , {θ}_{R} ) & ( 40 )\end{matrix}$$

The time derivative of the exergy potential function is

$$\begin{matrix}\text{?} {V}_{Ξ} \text{?} = {x}^{T} M \text{?} x \text{?} \\ = {x}^{T} [ R x + f ( x , u , v , t ) + {B}^{T} u + {D}^{T} v ]\end{matrix} \\ \text{?} \text{indicates text missing or illegible when filed} \qquad ( 41 )$$

with the electrical contribution as

$$( {V}_{Ξ} \text{?} ) \text{?} = {R}_{L } \text{?} ( {θ}_{c} ) {i}_{L }^{2} \text{?} - \frac{{v}_{C b}^{2}}{{R}_{C b}} - {R}_{L m} {i}_{L m}^{2} + u \text{?} {i}_{L e} + {u}_{b} v \text{?} + {u}_{m} {i}_{L m} - {P}_{load} + v \text{?} i \text{?} \\ \text{?} \text{indicates text missing or illegible when filed} \qquad ( 42 )$$

which are three dissipative, two generative, and three control (could be dissipative, generative, and/or storage) terms, the mechanical contribution as

$$( {\dot{V}}_{Ξ} ) = - {D}_{m} {ω}_{m}^{2} - {γ}_{m} {ω}_{m}^{3} \qquad ( 43 )$$

which are two dissipative terms, and the thermal contribution as

$$( \text{?} {V}_{Ξ} \text{?} ) \text{?} = \frac{1}{{T}_{o}} [ - {{R}_{12} ( {θ}_{c} - {θ}_{R} )}^{2} + {k}_{rg} {P}_{load} {θ}_{c} + {α}_{m} {ω}_{m} {R}_{u} ( {T}_{sw} - {θ}_{R} - {T}_{0} ) {θ}_{R} ] \\ \text{?} \text{indicates text missing or illegible when filed} \qquad ( 44 )$$

which are two dissipative and one generative terms.

The reference trajectory which may be optimal is

$$M {\dot{x}}_{r} = {Rx}_{r} + {f}_{r} ( {x}_{r} , {u}_{r} , v , t ) + {B}^{T} {u}_{r} + {D}^{T} v \qquad ( 45 )$$

The tracking exergy potential function is a positive-definite, quadratic function of the deviation state variables,

$${\tilde{V}}_{Ξ} = \frac{1}{2} {\tilde{x}}^{T} M \tilde{x} > 0 , ∀ \tilde{x} , \dot{\tilde{x}} \neq 0 \qquad ( 46 )$$

where ũ=uᵣ−u and \tilde{x}=xᵣ−x. This EMT system is statically stable relative to tracking the reference command. The time derivative of the tracking exergy potential function is

$$\begin{matrix}\text{?} {\tilde{V}}_{Ξ} \text{?} = {\tilde{x}}^{T} M \text{?} \tilde{x} \text{?} \\ = {\tilde{x}}^{T} [ R \tilde{x} + {f}_{r} ( {x}_{r} , {u}_{r} , v , t ) - f ( x , u , v , t ) + {B}^{T} \tilde{u} ] < 0\end{matrix}$$

$$\text{?} \text{indicates text missing or illegible when filed}$$

for dynamic stability. The limit cycle stability is determined from

$$∮ {\dot{\tilde{V}}}_{Ξ} dt = ∮ {\tilde{x}}^{T} [ R \tilde{x} + {f}_{r} ( {x}_{r} , {u}_{r} , v , t ) - f ( x , u , v , t ) + {B}^{T} \tilde{u} ] dt = 0 \qquad ( 47 )$$

For this model, the heat transfer terms appear to be damping terms. Since this model is based on the 1st law, there are no explicit irreversible entropy production or exergy destruction terms included in the equations of motion for the thermal part of the EMT model.

### Exergy Destruction from 2nd Law

The 1st law thermal model, shown in FIG. 4, is used to determine the irreversible entropy production and exergy destruction from the 2nd law and the entropy balance equations. The exergies for the railgun temperature and return water temperature are

$$\begin{matrix} Ξ \text{?} = ɛ \text{?} - {T}_{0} {S}_{c} & ( 48 ) \\ ɛ \text{?} = {m}_{c} {c}_{c} ( {T}_{c} - {T}_{0} ) & ( 49 ) \\ S \text{?} = {m}_{c} {c}_{c} ln ( {T}_{c} \text{/} {T}_{0} ) & ( 50 ) \\ {Ξ}_{R} = {h}_{R} - {T}_{0} {S}_{R} & ( 51 ) \\ {h}_{R} = {m}_{R} {c}_{R} ( {T}_{R} - {T}_{0} ) & ( 52 ) \\ {S}_{R} = {m}_{R} {c}_{R} ln ( {T}_{R} - {T}_{0} ) & ( 53 ) \\ Ξ \text{?} \text{?} = {C}_{T c} {T}_{c} \text{?} ( 1 - \frac{{T}_{0}}{{T}_{c}} ) = ɛ \text{?} \text{?} - {T}_{0} {S}_{c} \text{?} & ( 54 ) \\ {Ξ}_{R} \text{?} = {C}_{TR} {T}_{R} \text{?} ( 1 - \frac{{T}_{0}}{{T}_{R}} ) = {h}_{R} \text{?} - {T}_{0} {S}_{R} \text{?} \\ \text{?} \text{indicates text missing or illegible when filed} & ( 55 )\end{matrix}$$

where h is the enthalpy. The entropy balance equations from equation (2) for the railgun temperature and return water temperature are

$$\begin{matrix}{S}_{c} \text{?} = \frac{{C}_{T c} {T}_{c} \text{?}}{{T}_{c}} = {( {\sum }_{i} \frac{Q \text{?}}{T \text{?}} + {\sum }_{k} {m}_{k} \text{?} {s}_{k} + {S}_{ir} \text{?} )}_{c} = \frac{{k}_{rg}}{{T}_{c}} {P}_{load} + \frac{{R}_{12}}{{T}_{R}} ( {T}_{R} - {T}_{c} ) + {S}_{irc} \text{?} & ( 56 ) \\ {S}_{R} \text{?} = \frac{{C}_{T R} {T}_{R} \text{?}}{{T}_{R}} = - \frac{{R}_{12}}{{T}_{c}} ( {T}_{R} - {T}_{c} ) - {α}_{m} {ω}_{m} {R}_{u} ln ( \frac{{T}_{R}}{T \text{?}} ) + {S}_{irR} \text{?} \\ \text{?} \text{indicates text missing or illegible when filed} & ( 57 )\end{matrix}$$

Equations (56) and (57) can be solved for the irreversible entropy productions, \dot{S}_{irc} and S_{irR}, which can be summed and used as an optimization cost function (that minimizes the total exergy destruction) to determine the feed-forward control to maximize the efficiency of EMT systems. See, for example, G. G. Parker et al., ‘Exergy analysis of ship power systems’, in International Ship Control Systems Symposium, INEC, pp. 1-6 (2018); and E. H. Trinklein et al., ‘Reduced order multi-domain modeling of shipboard systems for exergy-based control investigations’, in ASNE Technology, Systems and Ships Symposia, ASNE, pp. 1-6 (2018).

### Extended Irreversible Thermodynamic (Thermal) Model

A thermal model can be developed that includes the irreversible entropy production or exergy destruction as ‘generalized dissipation terms’ and enables the derivation of a consistent set of coupled equations of motion for EMT systems. One way to do this is to utilize the concepts of EIT and Cattaneo's Law. Since the railgun is being subjected to a thermal pulse during the firing of the projectile, the thermal response of the railgun thermal mass and the cooling system may be better predicted by a thermal wave model. Cattaneo's Law produces a thermal wave model by modifying Fourier's Law of heat conduction by adding a heat flux relaxation term which creates a 2nd order differential equation in temperature. This 2nd order equation has the same form as a 2nd order mass-spring-damper model where the temperature replaces the mass position:

$$\begin{matrix}{}_{τ}^{}{C}{}_{Tc}^{} {\tilde{T}}_{c} + {C}_{Tc} {\dot{T}}_{c} + {R}_{12} ( {T}_{c} - {T}_{R} ) = {k}_{rg} {P}_{load} & ( 58 ) \\ {}_{τ}^{}{C}{}_{TR}^{} {\tilde{T}}_{R} + {C}_{TR} {\dot{T}}_{R} + {R}_{12} ( {T}_{R} - {T}_{c} ) = {α}_{m} {ω}_{m} {R}_{u} ( {T}_{sw} - {T}_{R} ) & ( 59 )\end{matrix}$$

where τ is the relaxation time. As τ→O the EIT/2^{nd} law model of equations (58)-(59) approaches the 1st law model of equations (27)-(28). These equations can be converted to exergy equations by utilizing the relative temperatures,

$$\begin{matrix}{θ}_{c} = ( {T}_{c} - {T}_{o} ) & ( 60 ) \\ {θ}_{R} = ( {T}_{R} - {T}_{o} ) & ( 61 )\end{matrix}$$

and the scaling defined by the thermal exergy potential function,

$${V}_{t} = \frac{ρ \text{?} V \text{?} {C}_{p} {θ}^{2}}{2 T \text{?}} \\ \text{?} \text{indicates text missing or illegible when filed} \qquad ( 62 )$$

The EM models are the same in this section and these new exergy-based differential equations contain the thermodynamic dissipation terms due to heat transfer.

### ESSTFC Design for the EIT/2nd Law Model

The exergy potential function for this EMT system is

$${V}_{Ξ} = {H}_{m} + {H}_{e} + {H}_{t} = \frac{{J}_{m} {ω}_{m}^{2}}{2} + \frac{L \text{?}}{2} + \frac{C \text{?} v \text{?}}{2} + \frac{{L}_{m} {i}_{L m}^{2}}{2} + \frac{\text{?} {C}_{Tc} \text{?} {θ}_{c}^{2} \text{?}}{2 T \text{?}} + \frac{\text{?} {C}_{TR} \text{?} {θ}_{R}^{2} \text{?}}{2 T \text{?}} + \frac{{{R}_{12} ( {θ}_{c} - {θ}_{R} )}^{2}}{2 {T}_{0}} = \frac{1}{2} {\tilde{x}}_{1}^{T} {\tilde{M}}_{1} {\tilde{x}}_{1} + \frac{1}{2 T \text{?}} \text{?} {\tilde{x}}_{2}^{T} {\tilde{\text{?} M}}_{2} \text{?} {\tilde{x}}_{2} \text{?} + \frac{1}{2 T \text{?}} {\tilde{x}}_{2}^{T} {\tilde{K}}_{2} {\tilde{x}}_{2} \\ \text{?} \text{indicates text missing or illegible when filed} \qquad ( 63 )$$

where the state vectors and matrices are

$${\tilde{x}}_{1}^{T} = ( {i}_{L} \text{?} , v \text{?} , {i}_{Lm} , {ω}_{m} ) , \\ {\tilde{x}}_{2}^{T} = ( {θ}_{c} , {θ}_{R} ) \\ {\tilde{M}}_{1} = [ \begin{matrix}L \text{?} & 0 & 0 & 0 \\ 0 & {C}_{b} & 0 & 0 \\ 0 & 0 & {L}_{m} & 0 \\ 0 & 0 & 0 & {J}_{m}\end{matrix} ] , \\ {\tilde{M}}_{2} = [ \begin{matrix}\text{?} {C}_{T c} & 0 \\ 0 & \text{?} {C}_{T R}\end{matrix} ] , \\ {\tilde{K}}_{2} = [ \begin{matrix}{R}_{12} & - {R}_{12} \\ - {R}_{12} & {R}_{12}\end{matrix} ] \\ \text{?} \text{indicates text missing or illegible when filed} \qquad ( 64 )$$

where the relative temperatures are defined as θ_{c}=(T_{c}−T₀) and θ_{R}=(T_{R}−T₀). Equation (30) is modified with the relative temperatures and the additional states.

$$\begin{matrix} {\tilde{M}}_{1} \text{?} {\tilde{x}}_{1} \text{?} = {\tilde{R}}_{1} \text{?} {\tilde{x}}_{1} \text{?} \tilde{{f}_{1}} ( {\tilde{x}}_{1} , {\tilde{x}}_{2} , u , v , t ) + {\tilde{B}}_{1}^{T} u + {\tilde{D}}_{1}^{T} v & ( 65 ) \\ {\tilde{R}}_{1} = [ \begin{matrix}- R \text{?} & - λ \text{?} & 0 & 0 \\ {λ}_{s} & - {R}_{Cb}^{- 1} & {λ}_{m} & 0 \\ 0 & {λ}_{m} & - {R}_{Lm} & - {k}_{m} \\ 0 & 0 & {k}_{m} & - {D}_{m}\end{matrix} ] \\ {\tilde{B}}_{1}^{T} = [ \begin{matrix}1 & 0 & 0 & 0 \\ 0 & 1 & 0 & 0 \\ 0 & 0 & 1 & 0 \\ 0 & 0 & 0 & 1\end{matrix} ] {\tilde{D}}_{1}^{T} = [ \begin{matrix}1 & 0 \\ 0 & 0 \\ 0 & 0 \\ 0 & 0\end{matrix} ] & ( 66 ) \\ {\tilde{f}}_{1} ( {\tilde{x}}_{1} , {\tilde{x}}_{2} , u , v , t ) = [ \begin{matrix}- R \text{?} {α}_{R} {θ}_{c} {i}_{Ls} \\ \frac{P \text{?}}{\text{?}} \\ 0 \\ - {γ}_{m} {ω}_{m}^{2}\end{matrix} ] & ( 67 ) \\ {\tilde{M}}_{2} \text{?} {\tilde{x}}_{2} \text{?} + {\tilde{R}}_{2} \text{?} {\tilde{x}}_{2} {\tilde{\text{?} K}}_{2} \text{?} {\tilde{x}}_{2} \text{?} = {\tilde{f}}_{2} ( {\tilde{x}}_{1} , {\tilde{x}}_{2} , u , v , t ) + {\tilde{D}}_{2}^{T} v & ( 68 ) \\ {\tilde{M}}_{2} = [ \begin{matrix}\text{?} {C}_{T c} & 0 \\ 0 & \text{?} {C}_{T R}\end{matrix} ] {\tilde{R}}_{2} = [ \begin{matrix}{C}_{T} \text{?} & 0 \\ 0 & {C}_{TR}\end{matrix} ] & ( 69 ) \\ {\tilde{K}}_{2} = [ \begin{matrix}{R}_{12} & - {R}_{12} \\ - {R}_{12} & {R}_{12}\end{matrix} ] {\tilde{D}}_{2}^{T} = [ \begin{matrix}0 & k \text{?} \\ 0 & 0\end{matrix} ] & ( 70 ) \\ {\tilde{f}}_{2} ( {\tilde{x}}_{1} , {\tilde{x}}_{2} , u , v , t ) = [ \begin{matrix}0 \\ {α}_{m} {ω}_{m} {R}_{u} ( {T}_{sw} - {θ}_{R} - T \text{?} )\end{matrix} ] \\ \text{?} \text{indicates text missing or illegible when filed} & ( 71 )\end{matrix}$$

The time derivative of the exergy potential function is

$$\begin{matrix}{V}_{Ξ} \text{?} = {\tilde{x}}_{1}^{T} {\tilde{M}}_{1} \text{?} {\tilde{x}}_{1} \text{?} + \text{?} {\tilde{x}}_{2}^{T} \text{?} [ {\tilde{M}}_{2} \text{?} {\tilde{x}}_{2} \text{?} + {\tilde{K}}_{2} {\tilde{x}}_{2} ] \\ = {\tilde{x}}_{1}^{T} [ {\tilde{R}}_{1} {\tilde{x}}_{1} + {\tilde{f}}_{1} ( {\tilde{x}}_{1} , {\tilde{x}}_{2} , u , v , t ) + {\tilde{B}}_{1}^{T} u + {\tilde{D}}_{1}^{T} v ] + \\ \frac{1}{{T}_{o}} \text{?} {\tilde{x}}_{2} \text{?} [ - {\tilde{R}}_{2} \text{?} {\tilde{x}}_{2} \text{?} + {\tilde{f}}_{2} ( {\tilde{x}}_{1} , {\tilde{x}}_{2} , u , v , t ) + {\tilde{D}}_{2}^{T} v ]\end{matrix} \\ \text{?} \text{indicates text missing or illegible when filed} \qquad ( 72 )$$

with the electrical contribution as

$$( {V}_{Ξ} \text{?} ) \text{?} = - \frac{{v}_{C b}^{2}}{{R}_{C b}} - {R}_{L m} {i}_{L m}^{2} - {R}_{L } \text{?} ( {θ}_{c} ) {i}_{L}^{2} \text{?} - {P}_{load} + v \text{?} {i}_{L} \text{?} + u \text{?} {i}_{L} \text{?} + {u}_{b} {v}_{Cb} + {u}_{m} {i}_{L m} \\ \text{?} \text{indicates text missing or illegible when filed} \qquad ( 73 )$$

which are three dissipative, two generative, and three control (could be dissipative, generative, and/or storage) terms, the mechanical contribution as

$${( {\dot{V}}_{Ξ} )}_{m} = - {D}_{m} {ω}_{m}^{2} - {γ}_{m} {ω}_{m}^{3} \qquad ( 74 )$$

which are two dissipative terms, and the thermal contribution as

$$( {V}_{Ξ} \text{?} ) \text{?} = \frac{1}{T \text{?}} [ - {C}_{T c} {θ}_{c}^{2} \text{?} - {C}_{TR} {θ}_{R}^{2} \text{?} + {k}_{rg} {P}_{load} {θ}_{c} + {α}_{m} {ω}_{m} {R}_{u} ( {T}_{sw} - {θ}_{R} - {T}_{0} ) {θ}_{R} ] \\ \text{?} \text{indicates text missing or illegible when filed} \qquad ( 75 )$$

which are three dissipative and one generative terms.

The reference trajectory which may be optimal is

$$\begin{matrix} {\hat{M}}_{1} \text{?} = {\hat{R}}_{1} \text{?} + \text{?} ( \text{?} , \text{?} , {u}_{r} , v , t ) + {\hat{B}}_{1}^{T} {u}_{r} + {\hat{D}}_{1}^{T} v & ( 76 ) \\ {\hat{M}}_{2} \text{?} = {\hat{R}}_{2} \text{?} + {K}_{2} \text{?} = \text{?} ( \text{?} , \text{?} , {u}_{r} , v , t ) + {\hat{D}}^{{T}_{2} v} . \\ \text{?} \text{indicates text missing or illegible when filed} & ( 77 )\end{matrix}$$

The tracking exergy potential function is a positive-definite, quadratic function of the deviation state variables.

$${\tilde{V}}_{•} = \frac{1}{2} {\tilde{x}}_{1}^{T} \hat{M} {\tilde{x}}_{1} + \frac{1}{2} {\dot{\tilde{x}}}_{2}^{T} {\hat{M}}_{2} {\dot{\tilde{x}}}_{2} + \frac{1}{2} {\tilde{x}}_{2}^{T} {\hat{K}}_{2} {\tilde{x}}_{2} > 0 , \\ ∀ {\tilde{x}}_{1} , \tilde{{x}_{2}} , {\dot{\tilde{x}}}_{2} \neq 0 \qquad ( 78 )$$

where \tilde{x}₁=\hat{x}ᵣ_{₁} . . . \hat{x}₁, \tilde{x}₂=\tilde{x}ᵣ_{₂} . . . \tilde{x}₂ and ũ=uᵣ . . . u.
This EMT system is statically stable relative to tracking the reference command. The time derivative of the tracking exergy potential function is

$$\begin{matrix}{\tilde{V}}_{Ξ} \text{?} = {\tilde{x}}_{1}^{T} \tilde{M} \text{?} {\tilde{x}}_{1} \text{?} + \text{?} {\tilde{x}}_{2}^{T} \text{?} [ {\tilde{M}}_{2} \text{?} {\tilde{x}}_{2} \text{?} + {\tilde{K}}_{2} {\tilde{x}}_{2} ] \\ = {\tilde{x}}_{1}^{T} [ {\tilde{R}}_{1} {\tilde{x}}_{1} + {\tilde{f}}_{1} ( {\tilde{x}}_{1} \text{?} , {\tilde{x}}_{2} \text{?} , u \text{?} , v , t ) - \\ {\tilde{f}}_{1} ( {\tilde{x}}_{1} , {\tilde{x}}_{2} , u , v , t ) + {\tilde{B}}_{1}^{T} \tilde{u} ] + \\ \frac{1}{{T}_{0}} \text{?} {\tilde{x}}_{2}^{T} \text{?} \text{?} [ - {\tilde{R}}_{2} \text{?} {\tilde{x}}_{2} \text{?} + \\ {\tilde{f}}_{2} \text{?} ( {\tilde{x}}_{1} \text{?} , {\tilde{x}}_{2} \text{?} , u \text{?} , v , t ) - \\ {\tilde{f}}_{2} ( {\tilde{x}}_{1} , {\tilde{x}}_{2} , u , v , t ) ] < 0\end{matrix} \\ \text{?} \text{indicates text missing or illegible when filed} \qquad ( 79 )$$

for dynamic stability. The limit cycle stability is determined from

$$\begin{matrix}∮ {V}_{Ξ} \text{?} = ∮ {\tilde{x}}_{1}^{T} [ {\tilde{R}}_{1} {\tilde{x}}_{1} + {\tilde{f}}_{1} ( {\tilde{x}}_{1} \text{?} , {\tilde{x}}_{2} \text{?} , u \text{?} , v , t ) - \\ {\tilde{f}}_{1} ( {\tilde{x}}_{1} , {\tilde{x}}_{2} , u , v , t ) + {\tilde{B}}_{1}^{T} \tilde{u} ] + \\ \frac{1}{{T}_{0}} \text{?} {\tilde{x}}_{2}^{T} \text{?} \text{?} [ - {\tilde{R}}_{2} \text{?} {\tilde{x}}_{2} \text{?} + \\ {\tilde{f}}_{2} \text{?} ( {\tilde{x}}_{1} \text{?} , {\tilde{x}}_{2} \text{?} , u \text{?} , v , t ) - \\ {\tilde{f}}_{2} ( {\tilde{x}}_{1} , {\tilde{x}}_{2} , u , v , t ) ] ) dt = 0\end{matrix} \\ \text{?} \text{indicates text missing or illegible when filed} \qquad ( 80 )$$

For this model, the heat transfer terms appear as exergy storage terms, and explicit damping terms are present which provide a consistent set of equations-of-motion for the EMT system. The 1st law model described in the previous section and the EIT/2nd law model described above have substantially different dynamics, as described below.

### Railgun EMT Examples

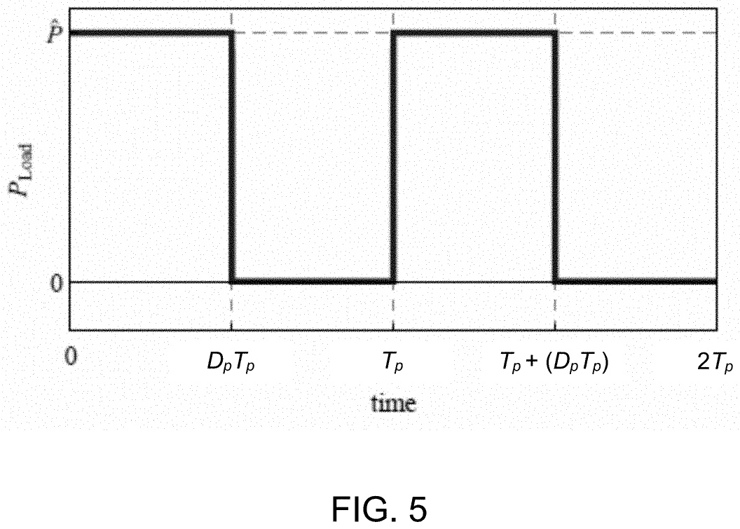

Simulation models of railgun EMT example systems for the ESSTFC design for 1st law and the exergy destruction from 2nd law described above were built in Wolfram Mathematica and the Modelica simulation language. See Modelica Association (2018) [online] https://www.modelica.org/ (accessed 17 Jul. 2018); Wolfram Research Inc. (2018) Mathematica, Version 11.3, Champaign, Ill.; and Wolfram Research Inc. (2018b) SystemModeler, Version 5.1, Champaign, Ill. Both the 1st law and EIT/2nd law models used the parameters and values given in Table 3. The load profile used for P_{load} of equation (24) is shown in FIG. 5. This load is a pulse width modulated (PWM) power signal that has a magnitude \hat{P}, a duty cycle Dₚ, and a period Tₚ. The simulations demonstrate that accuracy and stability predictions are heavily dependent upon the model and parameters used. One objective of the following examples is to illustrate that the EIT/2nd law EMT model has several important aspects and implications that need to be considered over the standard 1st law models. The designer and engineer of any EMT system needs to know and understand the parameters to best predict the system response and operating limits.

### 1st Law EMT Simulation

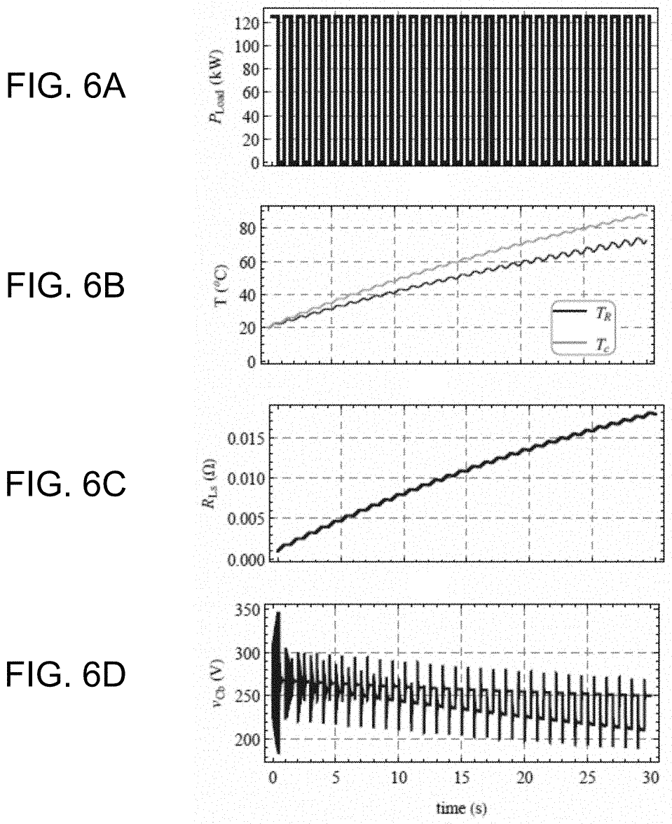

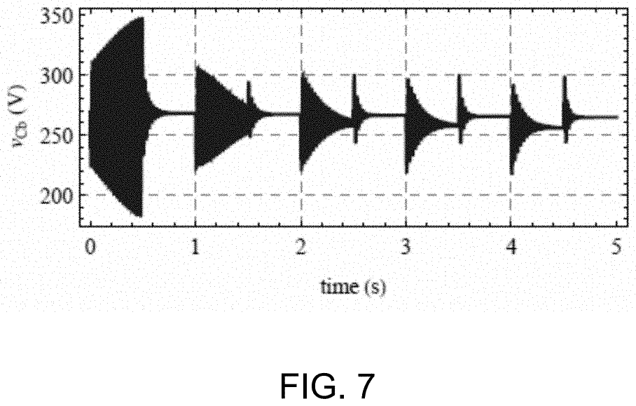

Simulations of railgun EMT example systems of the 1st law thermal model were performed. An example is shown in FIG. 6A, where the pulse load has parameters \hat{P}=50 kW, Dₚ=50%, Tₚ=1 s. As seen in FIG. 6B, at the initial temperature of 20° C. the damping in the system is very low, and large high frequency oscillations are seen in the bus voltage v_{Cb} at t<2 s, as shown in FIG. 6D. As the temperature rises the resistance R_{Ls}(T_{c}) also increases, as shown in FIG. 6C, and the voltage oscillations damp out. FIG. 7 shows the v_{Cb} in the first 5 s of FIG. 6D where the voltage oscillations are increasing for the first pulse, then continue to damp out for subsequent pulses as the temperature rises. However, as the temperature continues to climb the increase in resistance R_{Ls}(T_{c}) starts to cause a significant sag in v_{Cb} as time increases. Therefore, there are two distinct mechanisms that can cause bus voltage instability and collapse problems at low and high temperatures. Either low or high temperature effects on the bus voltage can violate power quality standards. See M. Amrhein et al., SAE International Journal of Aerospace, Vol. 3, No. 2010-01-1755, pp. 124-136. More about the 1st law EMT model stability is discussed in Dillon. See J. Dillon, Electro-Mechanical-Thermal Modeling and Stability of Pulsed Power Loads on a dc Network, Masters thesis, Michigan Technological University, Houghton Mich., USA (2018). However, the 1st law EMT model can yield limited or incomplete predictions for stability.

### EIT/2nd Law EMT Simulation

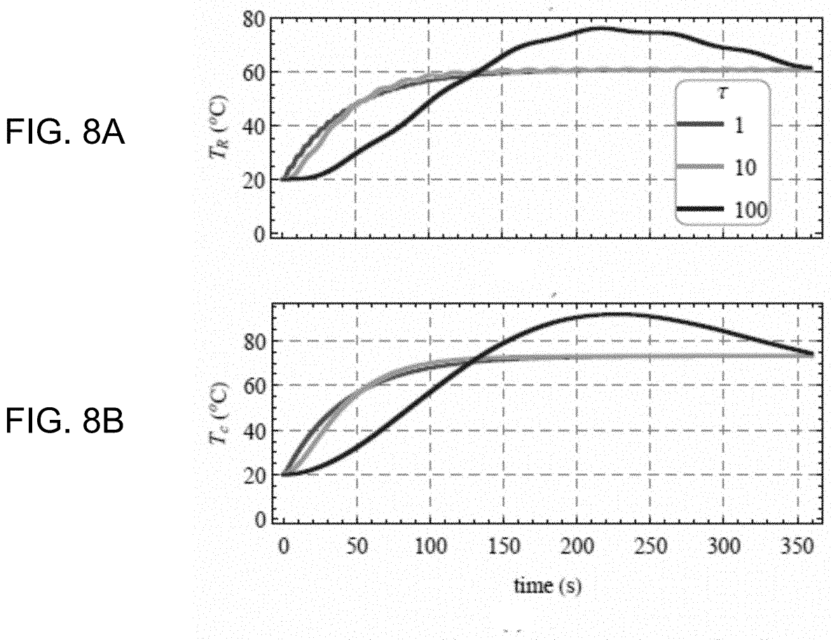

As seen in the simulation in FIGS. 6A-6D, the temperature plays a significant role in the power quality of the distribution bus voltage. To illustrate, the simulated temperatures T_{R} and T_{c} of the EIT/2nd law model [equations (58)-(59)] are shown in FIGS. 8A and 8B for three values of the relaxation time parameter τ. These figures show that as τ increases, the temperatures become under-damped. This has several important impacts, the first is that the temperature will take longer to rise, which can exacerbate the low temperature damping problems. The second main issue is that for larger τ the temperatures will have an overshoot, which can exacerbate the high temperature voltage sag problem.

### Low Temperature

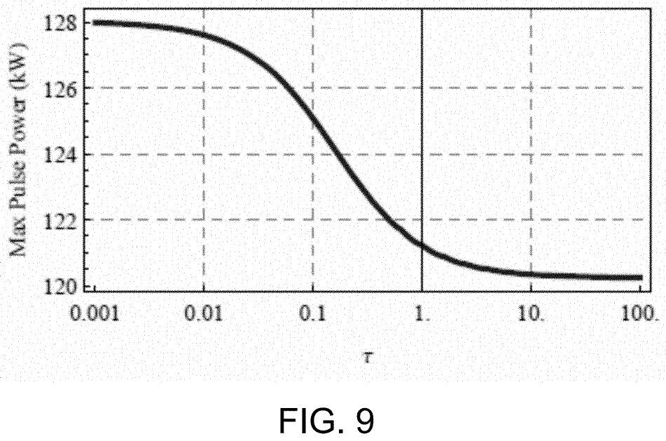

The EIT/2nd law simulation model was used to explore the effect that the relaxation time parameter τ has on the stable maximum power magnitude of the EMT system at starting low temperatures of T_{c}(t=0)=T_{R}(t=0)=20° C. For this study the system is defined as stable (or meta-stable, see W. W. Weaver et al., IEEE Transactions on Energy Conversion 32(2), 820 (2017)) if the bus voltage is bounded within defined limit set at 270 VDC±135 VDC. FIG. 9 shows the maximum pulse load magnitude \hat{P} over a log range of τ. In this simulation, the pulse load duty cycle and period were held constant at 50% and 1 s respectively. For a given value of τ, \hat{P} was increased until the voltage bound was violated on the first pulse after t=0⁺. As seen in FIG. 9 the maximum power magnitude decreases for larger τ. It should be noted again that the EIT/2nd law EMT model becomes the 1st law model as τ→0. This shows that it is important to know the value of τ to understand the stable limits at low temperatures.

### High Temperature

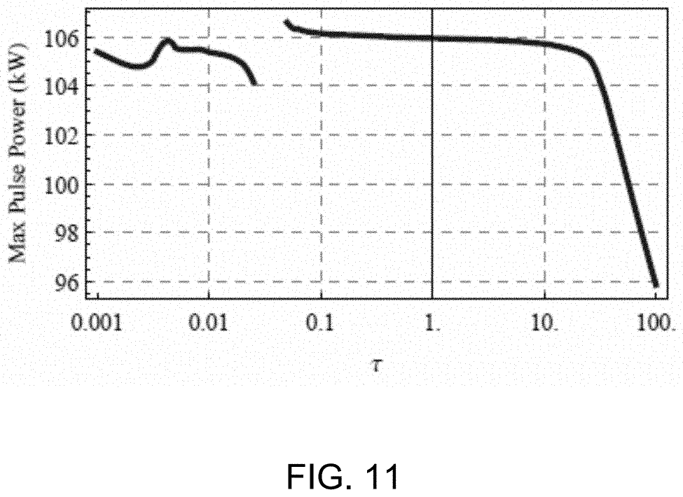

The sag in v_{Cb} due to the high temperature damping seen in FIG. 6D can also violate the stability boundaries. FIG. 11 shows the maximum pulse load magnitude \hat{P} over a log range of τ at higher temperatures. In this example, the simulation model was used to find the maximum load pulse magnitude that stayed within the bus voltage bound of 270 V_{DC}±135 V_{DC}. The limits were found when the simulation would no longer have a bounded periodic steady-state limit cycle on the voltage v_{Cb} at higher temperatures. FIG. 11 shows that the maximum load pulse magnitude at high temperatures (106.5 kW) is less than low temperatures (128 kW in FIG. 9).

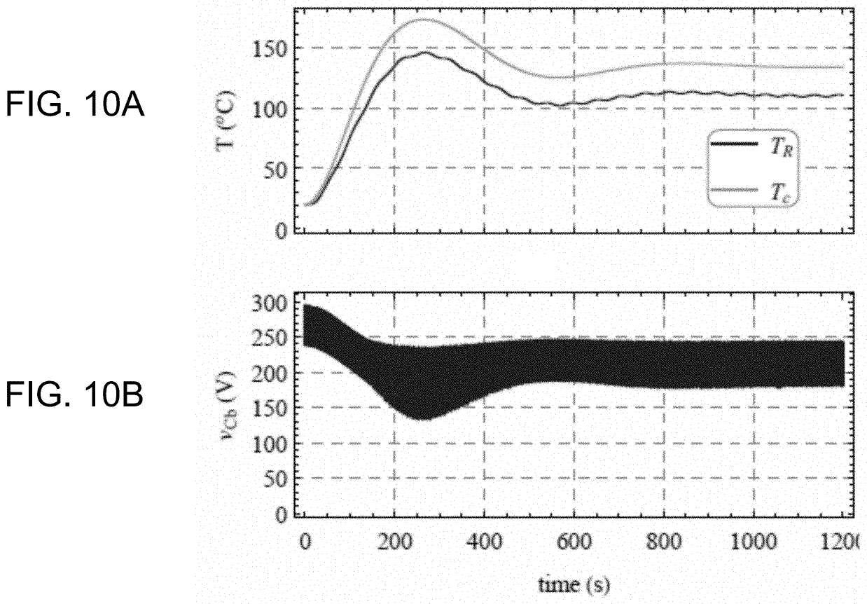

As an example, the EIT/2nd law EMT model was simulated with τ=100 and a PWM load of \hat{P}=50 kW, Dₚ=50%, and Tₚ=1 s with the results shown in FIGS. 10A and 10B. It is seen in FIG. 10A that the temperatures have overshoot and reach a peak at t=275 s. At the peak temperatures the bus voltage v_{Cb} also has its largest sag down to approximately 140 V, as shown in FIG. 10B.

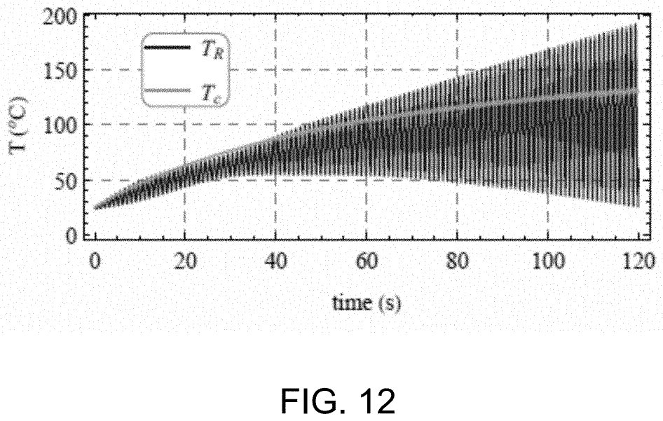

Another important result is shown in FIG. 11 for the range 0.001<τ<0.1. In this range of τ values it is the temperatures of the EIT/2nd law EMT model in equations (58)-(59) that are unstable. FIG. 12 shows the temperatures of a time domain simulation when τ=0.031. The oscillations on temperature T_{R} are growing with time. For this value of τ harmonics of the pulse load are exciting a resonance in the temperature modes. This example shows again that it is important to know and understand the EIT/2nd law EMT model parameters to be able to fully predict the system behavior.

The present invention has been described as exergy surface shaping and thermodynamic flow control of electro-mechanical-thermal systems. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A controller for an electro-mechanical-thermal (EMT) system that uses exergy surface shaping and thermodynamic flow control to minimize exergy destruction within the EMT system and maintain sufficient exergy destruction for stability of the EMT system.

2. The controller of claim 1, wherein the EMT system is statically and dynamically stable about an equilibrium point.

3. The controller of claim 2, wherein an exergy potential function is positive definite and wherein a sum of thermodynamic flows is negative definite over a representative cycle in time.

4. The controller of claim 3, wherein the thermodynamic flows comprise a power generator, power dissipator, and power storage.

5. The controller of claim 1, wherein the EMT system comprises
a thermal-sensitive generator providing voltage to a bus,
a pulse power load that receives pulse power from the bus to drive the load,
a thermal cooling loop to remove heat generated by the pulse power load,
a pump connected to the thermal cooling loop to circulate coolant therein, and
a permanent magnet DC machine that receives power from the bus to drive the pump,
wherein the controller provides sufficient power to the permanent magnet DC machine to cool the generator to prevent temperature overshoot and sag of the bus voltage, yet allow sufficient temperature rise to dampen high frequency fluctuations in the bus voltage.

6. The controller of claim 5, wherein the pulse power load comprises a railgun.
